(19) United States
(12) Patent Application Publication
(10) Pub. No.: US 2019/0345000 A1
(43) Pub. Date: Nov. 14, 2019

(54) ROBOTIC DESTINATION DISPATCH SYSTEM FOR ELEVATORS AND METHODS FOR MAKING AND USING SAME

(71) Applicants: ThyssenKrupp Elevator Corporation, Atlanta, GA (US); Georgia Tech Research Corporation, Atlanta, GA (US)

(72) Inventors: Shawn Park, Atlanta, GA (US); Michael Bray, Elkhorn, NE (US); Akansel Cosgun, Melbourne (AU); Henrik Christensen, San Diego, CA (US)

(21) Appl. No.: 15/974,406

(22) Filed: May 8, 2018

(51) Int. Cl. B66B 3/00; B66B 1/34; G05D 1/00

(52) U.S. Cl. CPC B66B 3/006; B66B 1/3461; B66B 2201/214; B66B 2201/103; G05D 1/0088

(57) ABSTRACT

One robotic destination dispatch system for elevators comprises a destination dispatch module configured to determine an optimal elevator for a passenger. The robotic destination dispatch system includes a guide robot in wireless data communication with the destination dispatch module. The guide robot has a processor in communication with a propelling device, a sensory device, and a memory comprising software. The software includes computer-readable instructions executable by the processor to: (a) implement an auction-based scheduling algorithm; (b) determine an identity of the passenger; (c) receive from the destination dispatch module the optimal elevator for the passenger; and (d) activate the propelling device to cause the guide robot to move and physically guide the passenger to the optimal elevator.

### FIELD OF THE DISCLOSURE

The disclosure relates generally to the field of elevator destination dispatch systems. More specifically, the disclosure relates to a robotic destination dispatch system for elevators and to methods of making and using this system.

### SUMMARY

Robotic destination dispatch systems and methods for making and using same are disclosed herein. In an embodiment, a robotic destination dispatch system for elevators comprises a destination dispatch module configured to determine an optimal elevator for a passenger. The robotic destination dispatch system includes a guide robot in wireless data communication with the destination dispatch module. The guide robot has a processor in communication with each of a propelling device, a sensory device, and a memory comprising software. The software includes computer-readable instructions executable by the processor to: (a) implement an auction-based scheduling algorithm; (b) determine an identity of the passenger; (c) receive from the destination dispatch module the optimal elevator for the passenger; and (d) activate the propelling device to cause the guide robot to move and physically guide the passenger to the optimal elevator.

In another embodiment, a method for physically guiding a passenger towards an elevator identified for the passenger comprises providing a guide robot. The guide robot has a processor in communication with each of a propelling device, a sensory device, and a memory comprising software. The method includes receiving an input comprising a destination floor. The method comprises causing the guide robot to move via the propelling device to physically guide the passenger to the identified elevator.

In yet another embodiment, a robotic destination dispatch system for elevators comprises a destination dispatch module configured to determine an optimal elevator for a passenger. The system includes a guide robot in wireless data communication with the destination dispatch module. The guide robot has a processor in communication with each of a propelling device, a sensory device comprising an imager, and a memory comprising software. The software has computer-readable instructions executable by the processor to activate the propelling device to cause the guide robot to move and physically guide the passenger to the optimal elevator. The robotic destination dispatch system includes a client device configured to allow the passenger to communicate with the guide robot.

In still yet another embodiment, a method for physically guiding a person from an initial location at a first elevation to a desired location at a second elevation (which is different from the first elevation) comprises providing at least one guide robot. Each guide robot has a processor in communication with each of a propelling device, a sensory device, and a memory comprising software. The method further includes receiving an input comprising a desired location, causing a first guide robot to move via its propelling device to physically guide the person to an elevator at the first elevation, and causing the first guide robot or a second guide robot to physically guide the person from the elevator at the second elevation to the desired location.

### BRIEF DESCRIPTION OF THE SEVERAL VIEWS OF THE DRAWINGS

Illustrative embodiments of the present disclosure are described in detail below with reference to the attached drawing figures and wherein:

FIG. 1 is a schematic representation of a robotic destination dispatch system for elevators, in an embodiment.

FIG. 2 is a schematic representation of a client device of the robotic destination dispatch system of FIG. 1.

FIG. 3 is a schematic representation of a guide robot of the robotic destination dispatch system of FIG. 1.

FIG. 4 is an example interface of the robotic destination dispatch system of FIG. 1.

FIG. 5 is a QR code usable by the guide robot of FIG. 3 to determine its position and orientation.

FIG. 6 is a flowchart illustrating a method of using the robotic destination dispatch system of FIG. 1, in an embodiment.

FIG. 7 is a flowchart illustrating a method of using the robotic destination dispatch system of FIG. 1, in another embodiment.

### DETAILED DESCRIPTION

Elevators, which were once installed in a select few buildings, have now become ubiquitous. According to the National Elevator Industry, Inc., there are about a million elevators in the United States alone, which are collectively used about eighteen billion times a year to transport one or more passengers from one floor to another. Each elevator may include an elevator interface, which is typically provided inside the elevator (e.g., adjacent the door thereof). A passenger may enter an elevator and employ the interface to select his or her destination floor. An elevator controller in data communication with the elevator interface may subsequently cause the elevator to travel to the floor selected by the passenger.

Some buildings may include an elevator bank comprising two or more elevators. When a passenger calls an elevator, e.g., to the lobby of a building, the closest elevator may be assigned to the call. Once the elevator reaches the lobby, all the passengers waiting for an elevator in the lobby may attempt to board the elevator, until, e.g., the elevator is full. Such may be operationally inefficient. Some of the passengers aboard the elevator may be headed to lower floors, whereas other passengers aboard the elevator may be headed to higher floors. The elevator may consequently make many stops, which may needlessly increase the average time it takes for a passenger to reach his or her desired floor.

Elevator destination dispatch systems were recently introduced to address this problem. An elevator destination dispatch system may include one or more destination dispatch kiosks that are in data communication with an elevator destination dispatch module. The destination dispatch kiosks are conventionally located outside the elevators to allow each passenger to indicate his or her destination floor (or other location) before boarding an elevator. The elevator destination dispatch module may include or have associated therewith a processor and a memory housing algorithms directed generally to minimizing the average time it takes for passengers to reach their respective destination floors via the elevators. For example, and as is known, the elevator destination dispatch system may, via the destination dispatch kiosks, facilitate grouping of elevators' passengers based on their destination floors.

Each destination dispatch kiosk may include input device(s) (e.g., input keys, buttons, switches, etc.) and output devices(s) (e.g., a display, a speaker, a warning light, etc.). The touchscreen may display, among other content, a plurality of floor buttons, each of which may be associated with a particular destination floor. A passenger wishing to board an elevator may interact with (e.g., press) a floor button on the destination dispatch kiosk touchscreen to indicate his or her desired destination floor, and the kiosk may use this input to call an elevator for the passenger. The destination dispatch kiosk may then communicate with the elevator destination dispatch module, e.g., with the processor thereof, to identify the particular (optimal) elevator the passenger is to take to reach his destination floor efficiently (the elevator identified by the destination dispatch module may be the next elevator to arrive at the passenger's floor or a different elevator). The destination dispatch kiosk may employ the touchscreen to communicate the identity of the optimal elevator determined by the destination dispatch module to the passenger. For example, the kiosk touchscreen may display imagery (e.g., arrows, text indicating that the passenger is to move in a straight line, take a right turn, take a left turn, etc., text indicating the number of the identified optimal elevator, and so on) intended to guide the passenger towards the optimal elevator identified for the passenger by the elevator destination dispatch module.

These elevator destination dispatch systems, while a significant advance over the prior art wherein the passenger simply took the next elevator to arrive at the passenger's floor, are not without flaws. One shortcoming of the destination dispatch systems stems from the fact that their accuracy is limited by the user input. For example, where a plurality of passengers is waiting to take an elevator, only one passenger may use the kiosk to enter his or her destination floor whereas the others may not. The algorithm employed by the destination dispatch module may therefore assume that a solitary passenger is going to the intended floor, and identify an elevator based in part on this assumption. However, when the elevator arrives on the floor to pick up the passenger, all the passengers (including the passengers that did not enter a destination floor) may come aboard the elevator and cause the elevator cab to be overfilled. Such may be undesirable.

The prior elevator destination dispatch systems are also deficient in that they may from time to time fail to guide a passenger as desired. For instance, an elevator destination dispatch kiosk may fail to effectuate its purpose in situations where a passenger is unable to properly decipher the imagery displayed on the touchscreen thereof, does not pay due attention thereto, and/or becomes confused thereby. In these situations, the passenger may enter an elevator other than the elevator identified for that passenger by the destination dispatch module, which may cause the passenger to end up at the wrong floor and/or may otherwise adversely affect the efficiency of the elevator system.

To overcome such deficiencies, it may be desirable to have in place an elevator destination dispatch system that, instead of and/or in addition to destination dispatch kiosks, includes one or more robots that physically guide the passengers to the elevator(s) identified by the elevator destination dispatch module. The present disclosure may, among other things, provide for such.

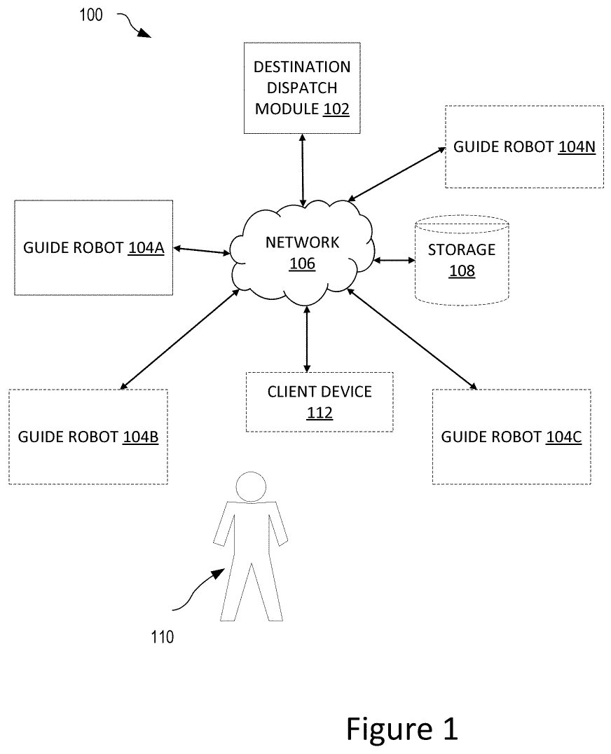

Focus is directed now to FIG. 1, which schematically illustrates a robotic destination dispatch system 100, in an embodiment. The robotic destination dispatch system 100 may be configured at least in part within a structure, e.g., an office building, a residential building, a hotel, etc. that contains a plurality of elevators. The guide robots of the system 100, discussed further below, may be provided on the ground floor of the structure (e.g., within the lobby, or in another area). Alternately or in addition, the guide robots may be provided on other floors (e.g., in lobby of the second floor, in the hallway of the third floor proximate the elevators, etc.) within the structure.

The robotic destination dispatch system 100 may comprise a destination dispatch module 102 and a guide robot 104A that are in wireless (and/or wired) data communication with each other, e.g., over a network 106. The destination dispatch module 102 may, in general, be adapted to identify for a passenger or group of passengers an elevator that takes the passenger(s) to their destination floor(s) in the shortest amount of time. The artisan understands that the destination dispatch module 102 may comprise a processor and a memory housing algorithms that allow for grouping of passengers based on their destination floor, and thereby, reduces the number of elevator stops and improves the efficiency of the building elevator's traffic. Because destination dispatch modules 102 (used in the prior art with destination dispatch kiosks) are known, a more exhaustive discussion thereof is not provided herein.

The guide robot 104A may be configured to physically guide a passenger 110 to an elevator identified by the destination dispatch module 102. The passenger 110 may be a solitary passenger or a group of passengers. The system 100 may, in embodiments, optionally include a plurality of guide robots, e.g., guide robots 104A, 104B, 104C, and 104N. The guide robot 104N indicates that any number of guide robots may be employed in the system 100. The guide robot 104A may be generally identical to guide robot 104B and the other guide robots, except as expressly disclosed herein and/or would be inherent or inconsequential. The guide robots 104A-104N are discussed in more detail below.

The network 106 may be a wireless network, a wired network, or a combination thereof. For example, the network 106 may include one or more of the following: a PSTN, the Internet, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a DSL (Digital Subscriber Line) connection, an Ethernet connection, an ISDN (Integrated Services Digital Network) line, a dial-up port such as a V.90, V.34, or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), LTE, VoLTE, LoRaWAN, LPWAN, RPMA, LTE Cat-“X” (e.g. LTE Cat 1, LTE Cat 0, LTE CatM1, LTE Cat NB1), CDMA (Code Division Multiple Access), TDMA (Time Division Multiple Access), FDMA (Frequency Division Multiple Access), and/or OFDMA (Orthogonal Frequency Division Multiple Access) cellular phone networks, GPS, CDPD (cellular digital packet data), RIM (Research in Motion, Limited) duplex paging network, Bluetooth radio, or an IEEE 802.11-based radio frequency network. The network 106 may further include or interface with any one or more of the following: RS-232 serial connection, IEEE-1394 (Firewire) connection, Fibre Channel connection, IrDA (infrared) port, SCSI (Small Computer Systems Interface) connection, USB (Universal Serial Bus) connection, or other wired or wireless, digital or analog, interface or connection, mesh or Digi® networking. In a currently preferred embodiment, the network 106 may be a wireless network (e.g., a PAN, a LAN, a WAN, a MAN, a VPN, a SAN, a Bluetooth Network, or any other wireless network now known or subsequently developed) and/or at least includes a wireless component.

The robotic destination dispatch system 100 may include storage 108. The storage 108 may be local storage and/or network storage (e.g., storage that is external to the structure and is accessible by the module 102 and/or the guide robots 104A-104N via the network 106, such as cloud storage). The storage 108 may be encrypted, password protected, and/or otherwise secured. The storage 108 may store all or part of the information required by the system 100 to effectuate its functions, as described herein. The artisan will understand that the storage 108 may but need not be unitary.

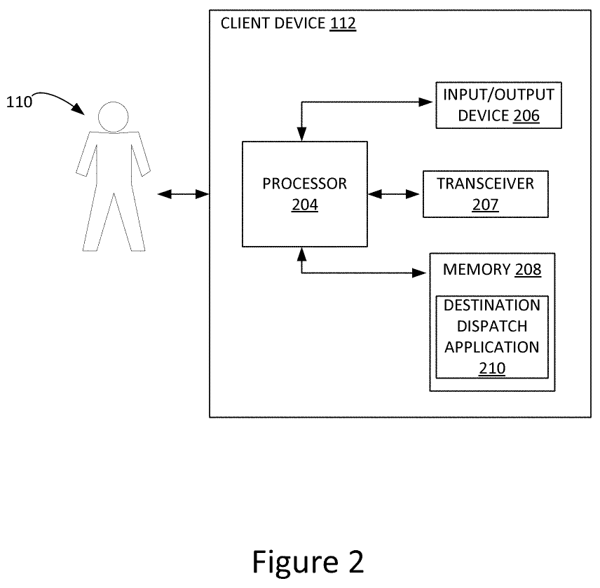

In embodiments, the system 100 may include a client device 112, which may be employed by the passenger 110 to interact with the system 100. The client device 112 may be a computing device, such as a mobile computing device (e.g., a laptop, a tablet, an Android®, Apple®, or other smart phone, etc.). For example, the client device 112 may be the general purpose smart phone (or other device) used by the passenger 110. Or, for instance, the client device 112 may be a dedicated device, such as a computerized fob, a key card, etc. The example client device 112 is shown in more detail in FIG. 2, and focus is now directed thereto.

The client device 112 may comprise a processor 204 in data communication with an input/output device 206, a transceiver 207, and a memory 208. The processor 204 may include one or more processors, such as one or more microprocessors, and/or one or more supplementary co-processors, such as math co-processors. Where the client device 112 is a smart phone or other portable computing device, the processor 204 may include any processor used in smartphones and/or portable computing devices, such as an ARM processor (a processor based on the RISC (reduced instruction set computer) architecture developed by Advanced RISC Machines (ARM)).

The input/output device 206 may comprise any suitable input and/or output device, such as a display, a speaker, a microphone, a retinal scanner, a touch screen, etc., for allowing the passenger 110 to interact with the system 100 (e.g., with the guide robot 104A thereof) via the client device 112.

The transceiver 207 may be a wireless transceiver and/or a wired transceiver. The transceiver 207 may allow the passenger 110 to convey information to and/or otherwise communicate with the guide robot 104A. For example, the passenger 110 may input a command (such as a destination floor) on the input/output device 206 and the transceiver 207 may communicate said command to the guide robot 104A over the network 106.

In embodiments, the transceiver 207 (or another component of the client device 112) may be configured for near-field communication. For instance, in embodiments, the passenger 110 may tap the robot 104A with the client device 112 and/or wave the client device 112 when it is proximate the robot 104A to communicate a message (e.g., the intended floor) to the robot 104A. The destination dispatch application 210 need not be open on the client device 112 and the client device 112 need not be unlocked for this functionality to be effectuated; rather, the passenger 110 may tap the guide robot 104A with the client device 112 even where the client device 112 is locked to cause the client device 112 to transmit elevator information of the passenger 110 to the guide robot 104A. Of course, the passenger 110 may change the elevator information (e.g., the destination floor and other relevant information as discussed herein) using the destination dispatch application 210 at any time.

The memory 208 may be transitory memory, non-transitory memory, or a combination thereof. In embodiments, the memory 208 may include a destination dispatch application 210. The destination dispatch application 210 may be stored in a transitory and/or a non-transitory portion of the memory 208. The destination dispatch application 210 is software and/or firmware that contains machine-readable instructions executed by the processor 204 to perform the functionality of the client device 112 as described herein. In embodiments where the client device 112 is a smart phone, the destination dispatch application 210 may be a mobile application that is downloaded by the passenger 110 onto the client device 112 (e.g., via the World Wide Web or via other means) to allow the passenger to interact with components of the system 100 as desired.

The destination dispatch application 210 may, during setup or otherwise, collect information that uniquely identifies the passenger 110 and/or the client device 112, so that the system 100 (e.g., the destination dispatch module 102, the guide robot 104A, etc.) may correlate a message communicated by the client device 112 to the particular passenger 110. In some embodiments, the passenger 110 may be allowed to enter into the destination dispatch application 210 information regarding his intended use of the elevators within the structure; for instance, the passenger 110 may use the input/output device 206 to enter into the destination dispatch application 210 his or her destination floor. The artisan will appreciate that a robotic destination dispatch system 100 may be employed in each of a plurality of structures, and in these embodiments, the passenger 110 may be allowed to use the input/output device 206 of the client device 112 to selectively indicate his or her desired use of the elevator in each such structure.

In embodiments, the destination dispatch application 210 may allow the passenger 110 to create a robust passenger profile. The destination dispatch application 210 may have an interface to enable the user to create such a profile. The profile may include the name of the passenger 110, the name of his or her employer, the destination floor, the type of the client device 112 (e.g., an Android® device, an Apple® device, etc.), a unique identification number identifying the client device 112, etc. The interface may also allow the user to set his or her elevator preferences and requirements as part of his profile (e.g., the passenger 110 may indicate that he or she prefers not to ride the elevator with a specific individual, prefers not to ride the elevator with more than five people, requires the door of the elevator to open for the passenger 110 for an extended time period, etc.). In some embodiments, the passenger 110 may capture an image of himself or herself (e.g., of the face) using a camera of the client device 112, and this image may be stored as part of the profile. The profile may be stored in the storage 108 and may be accessible to the destination dispatch module 102.

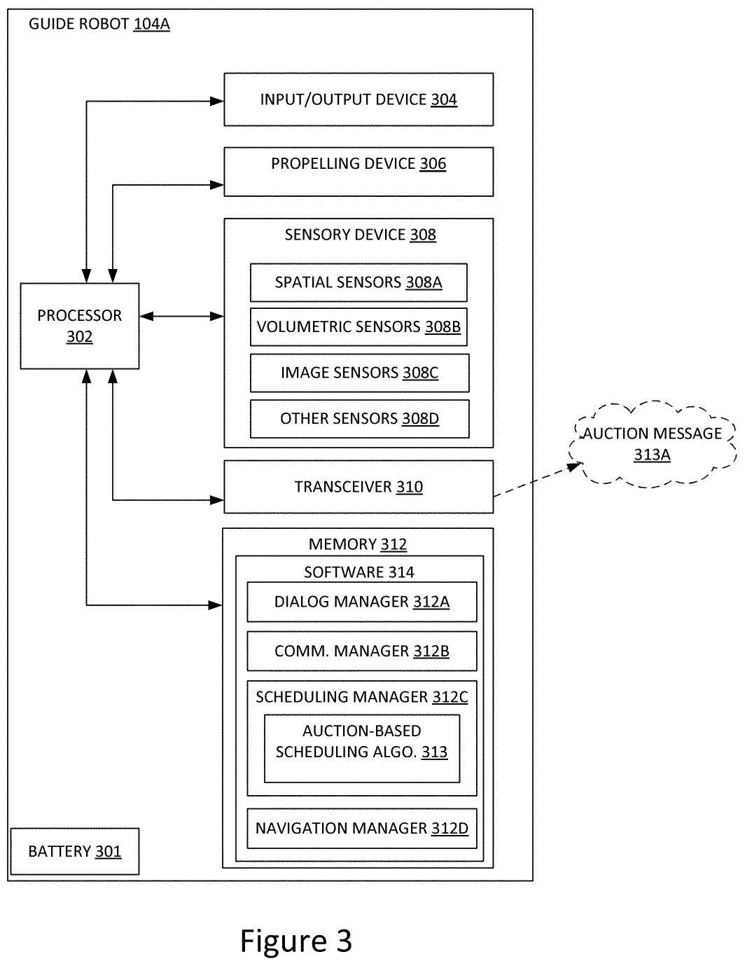

FIG. 3 is a schematic representation of the guide robot 104A, in an example embodiment. The guide robot 104A may include a battery 301, and a processor 302 in data communication with each of an input/output device 304, a propelling device 306, a sensory device 308, a transceiver 310, and a memory 312. The guide robot 104A may have a housing (or a plurality of housings) in which one or more of the components and/or portions thereof may be housed.

The battery 301 may be any suitable battery usable to power the guide robot 104A, such as a lithium battery, a lithium-ion battery, a nickel-cadmium battery, etc. The battery 301 may, in embodiments, be rechargeable (e.g., an administrator of the system 100 may charge the battery wirelessly; alternately or in addition, the robot housing may have a port for allowing the administrator to charge the battery 301 via a USB or other wired connection). In embodiments, the battery 301 may be disposable (e.g., the housing may have an openable section for allowing the administrator to replace the battery 301). In embodiments, the battery 301 may comprise two or more batteries (e.g., a portable battery, a rechargeable battery, a disposable battery, etc.).

The processor 302 may be any suitable processor, such as a microprocessor, a co-processor, etc. The input/output device 304 may comprise any suitable input and/or output device, such as a display, a speaker, a microphone, a retinal scanner, a touch screen, etc., for allowing the passenger 110 (or another, e.g., an owner or operator of the system 100, the structure, and/or the elevators) to interact with the guide robot 104A. In embodiments, the guide robot 104A may include a computing device, such as a tablet or a smart phone, and the processor and input/output device (e.g., touch screen, speakers, buttons, etc.) thereof may serve as the processor 302 and the input/output device 304 of the guide robot 104A.

The propelling device 306 may include actuating motors, powered wheels, caterpillar tracks, and/or another suitable device that allows the guide robot 104A to physically move from one location to another generally in the x-y plane (e.g., allows the guide robot 104A to move along the floor or other ground surface from one location to another). The propelling device 306 may be activated by the processor 302 and the software 314 to cause the guide robot 104A to move and physically guide the passenger 110 towards the identified elevator as discussed herein.

The sensory device 308 may include one or more sensors to allow the guide robot 104A to determine its position and location, selectively move from one location to another, distinguish between a human being and an object, identify a human being such as the passenger 110, avoid an obstacle in its path, etc. In an embodiment, the sensory device 308 may include spatial sensors 308A, volumetric sensors 308B, image sensors 308C, and other sensors 308D. The artisan will understand that not all sensors 308A-308D need to be present in all embodiments.

The spatial sensors 308A may include sensors to allow the guide robot 104A to determine its location so that the guide robot 104A may selectively move from that location to another location by activating the propelling device 306. For example, and as discussed herein, the spatial sensors 308A, together with the processor 302, the memory 312, and the propelling device 306, may allow the guide robot 104A to move from a location proximate the passenger 110 to a location proximate the elevator identified for the passenger 110 by the destination dispatch module 102. In an embodiment, the spatial sensors 308A may include laser scanners that allow the guide robot 104A to create a map of the floor plan of the area within which the elevators are located. Alternately or additionally, the spatial sensors 308A may include a sonar device, an infrared proximity detector, a Hall Effect sensor, an accelerometer, a magnetic positioning sensor, a gyrometer, a motion detector, etc. to allow the guide robot 104A to move generally in the x-y plane to guide the passenger 110 to the identified elevator.

The volumetric sensors 308B may include sensors to allow the guide robot 104A to distinguish between a human being (e.g., the passenger 110) and an object. The volumetric sensors 308B may also allow the guide robot 104A to determine the proximity of the passenger 110 and objects, e.g., to the guide robot 104A, to the elevator bank, etc. The volumetric sensors 308B may include any active or passive sensor, such as an infrared sensor and/or another suitable sensor.

The image sensor 308C may include still and/or video image capturing devices, such as RGBD, CMOS, CCD, and/or other suitable imaging sensors. In embodiments, when the passenger 110 downloads the destination dispatch application 210, he or she may provide his or her image thereto via a camera of the client device 112. This image may be stored in the storage 108 in a profile of the passenger 110. When the passenger 110 is proximate the guide robot 104A, the guide robot 104A may use the image sensor 308C to capture an image of the passenger 110. Image processing algorithms stored e.g., in the memory 312, may then compare the images of the various passengers stored in the storage 108 with the image now captured by the image sensor 308C to determine the identity, and thereby the intended floor, of the passenger 110.

In some embodiments, the passenger 110 may walk up the robot 104A to cause the guide robot 104A to take a plurality of (e.g., a hundred) pictures of the face of the passenger 110. The guide robot 104A may then use a PCA-based classifier for recognition. Then, whenever the face is recognized by the guide robot 104A multiple times during a short time period, the destination dispatch module 102 may determine the optimal elevator for the identified passenger 110.

The other sensors 308D may include one or more sensors not specifically discussed above to allow the guide robot 104A to function in line with the requirements of the particular application. For example, where the guide robot 104A is configured to carry objects into the elevator, the guide robot 104A may have a weight sensor or other suitable sensor to allow the guide robot 104A to ensure that the collective weight of the objects does not exceed the maximum weight capacity of the elevator.

The transceiver 310 may be a wireless transceiver that may allow the guide robot 104A to wirelessly communicate with the client device 112 and the destination dispatch module 102.

Memory 312 represents one or more of volatile memory (e.g., RAM) and non-volatile memory (e.g., ROM, FLASH, magnetic media, optical media, etc.). Although shown within the guide robot 104A, memory 312 may be, at least in part, implemented as network storage that is external to the robot 104A and accessed thereby over the network 106. The memory 312 may house software 314, which may be stored in a transitory or non-transitory portion of the memory 312. Software 314 includes machine readable instructions that are executed by processor 302 to perform the functionality of the guide robot 104A as described herein. In some example embodiments, the processor 302 may be configured through particularly configured hardware, such as an application specific integrated circuit (ASIC), field-programmable gate array (FPGA), etc., and/or through execution of software (e.g., software 314) to perform functions in accordance with the disclosure herein.

In an embodiment, the software 314 may include a dialog manager 312A, a communications manager 312B, a scheduling manager 312C, and a navigation manager 312D. Each of these managers may be software modules that may, in embodiments, provide information to and/or receive information from other components of the robot 104A (e.g., the dialog manager 312A may receive information from the input/output device 304, the sensory device 308, and/or the transceiver 310; the navigation manager 312D may provide information to the propelling device 306; the communications manager 312B may receive information from the dialog manager 312A, etc.).

In more detail, the dialog manager 312A may be responsible for receiving input from or about the passenger 110. The input received by the dialog manager 312A may be entered by the passenger 110 manually, and/or the input may be obtained by the dialog manager 312A automatically. For example, where the passenger 110 employs the input/output device 304, e.g., a touchscreen, to enter in his or her destination floor manually, the dialog manager 312A may be configured to receive and decipher same. Or, for instance, if the image sensor 308C captures an image of the passenger 110, the dialog manager 312A may employ image processing algorithms to compare the captured image with the images supplied by the various passengers during setup of the destination dispatch application 210 to ascertain the identity (and therefore the destination floor and other preferences and requirements) of the passenger 110. In embodiments, the passenger 110 may wirelessly communicate his desired floor (and/or other preferences and requirements) to the guide robot 104A via the client device 112.

In embodiments, the guide robot 104A may be configured to detect and track the passenger 110 using more than one source. For example, in embodiments, the guide robot 104A may be configured to detect the passenger 110 anywhere in the 360 degree area around the robot. The ability to detect the passenger 110 in the 360 degree area surrounding the robot may increase robustness of the detection (relative to front facing detection alone, for example).

In an embodiment, the legs of the passenger 110 may be detected using the spatial sensors 308A, e.g., the laser scanner, provided at the front of the guide robot 104A. The guide robot 104A may use geometric features of the legs, such as their width and circularity, to identify same. The torso of the passenger 110 may be detected using the laser scanner provided at the back of guide robot 104A. The torsos may be modeled as ellipses for detection. The body of the passenger 110 may be detected using the image sensor 308C, e.g., the RGBD (or other) camera in front of the robot. Detections of the legs, torso, and body may occur asynchronously, and the guide robot 104A may use principles involving multisensory fusion (e.g., an Extended Kalman Filter with nearest neighbor data association) to fuse the information into coherent, usable blocks.

The dialog manager 312A may also be configured to provide feedback to the passenger 110. For example, the dialog manager 312A may display words or strings for consumption by the passenger 110 via the input/output device 304. Where the passenger 110 indicates a desire to follow the guide robot 104A to the elevator identified for the passenger 110 by the module 102, as discussed herein, the dialog manager 312A may communicate with the navigation manager 312D and convey this desire of the passenger 110 thereto.

The communications manager 312B may be in charge of communication between robots, such as between the guide robot 104A and the other robots 104B-104N. The communication between robots 104A-104N may thus be effectuated over the network 106 (e.g., a Wi-Fi network, an ad-hoc network, or any other network as discussed above) in addition to, or instead of, directly between the guide robots 104A-104N (point-to-point). The communications manager 312B may also be configured to allow the guide robot 104A to wirelessly communicate with the destination dispatch module 102.

The scheduling manager 312C may be configured to determine which guide robot 104A-104N is to be assigned to the passenger 110. In embodiments, an auction-based scheduling algorithm 313 may be deployed to coordinate the behavior of the guide robots 104A-104N. In embodiments, the guide robot 104A may operate in line with the auction-based scheduling algorithm 313 as follows.

Each time a guide robot, e.g., guide robot 104A, receives an input regarding a destination floor, such as an automatic or manual input, the guide robot 104A may (via the transceiver 310 or otherwise) broadcast an auction message 313A (FIG. 3) intended for the other guide robots 104B-104N. In an embodiment, the auction message 313A may have the format:
[P, ETA, R]
   where P is the identity and position of the passenger 110, ETA is the estimated time of arrival of the guide robot 104A to the passenger 110, and R is the identity of the guide robot broadcasting the message (i.e., guide robot 104A in this example). Each time the auction message 313A is received by another robot (e.g., guide robot 104B), the guide robot receiving the message 313A calculates its own estimated time of arrival to the passenger 110 and broadcasts it to the other guide robots 104A and 104C-N. If the estimated time of arrival of a robot (e.g., guide robot 104B) is shorter than the estimated time of arrival of the robot that transmitted the auction message 313A regarding the passenger 110 (i.e., guide robot 104A in this example), the broadcaster of the auction message 313A (i.e., guide robot 104A in this example) loses the auction (to guide robot 104B) and takes no action. Alternately, if the estimated time of arrival of the guide robot 104A is shorter than the estimated time of arrival of the guide robot 104B (and the other robots), the guide robot 104A wins the auction and is assigned by the scheduling manager 312C to serve the passenger 110. The artisan will understand that by virtue of this auction-based scheduling algorithm 313, only one guide robot (e.g., guide robot 104A) serves the passenger 110 at a time and the robot 104A-104N with the shortest ETA is chosen to increase efficiency. Whenever a robot wins an auction, the navigation manager 312D may be called.

The navigation manager 312D may be responsible for handling requests to go to a location, to approach the passenger 110, and/or to follow/guide the passenger 110 towards the elevator assigned to the passenger 110 by the destination dispatch module 102. More specifically, the navigation manager 312D may use the sensory device 308, e.g., the spatial sensors 308A and/or the other sensors thereof, to cause the guide robot 104A to move via the propelling device 306 to physically guide the passenger 110 to the assigned elevator. For example, in embodiments, the navigation manager 312D may use a laser scanner to generate an obstacle map at regular time intervals. Using the scanner data, the guide robot 104A may localize itself in the environment, detect passengers, track passengers, and/or avoid obstacles.

The navigation manager 312D may also be configured to control the speed of the guide robot (e.g., the guide robot 104A). In embodiments, the speed of the guide robot 104A may be adjusted in response to external conditions. For example, the navigation manager 312D may cause the guide robot 104A to travel at a faster speed when the guide robot 104A is traveling in a straight line and to travel at a slower speed during turns to ensure that the robot 104A does not inadvertently fall over. Or, for instance, the navigation manager 312D may cause the propelling device 306 to propel the robot 104A through the lobby at one speed when the lobby is empty and at another (slower) speed when the lobby is filled with passengers.

In embodiments, the path chosen by the guide robot 104A to guide the passenger 110 to the assigned elevator may be the shortest path. In other embodiments, the path chosen by the guide robot 104A to guide the passenger 110 to the assigned elevator may be the most predictable and/or socially responsible path (e.g., the path which least endangers the safety of the passenger 110 and/or other people).

The guide robot 104A may be capable of planning a path to a goal location (discussed further below) and navigating autonomously by avoiding obstacles in its path. In embodiments, the path planning may be effectuated using a two-tiered approach. First a long term global plan may be found using the map, and then the software 314 may set the velocity and direction of the guide robot 104A to cause the guide robot 104A to remain on the path.

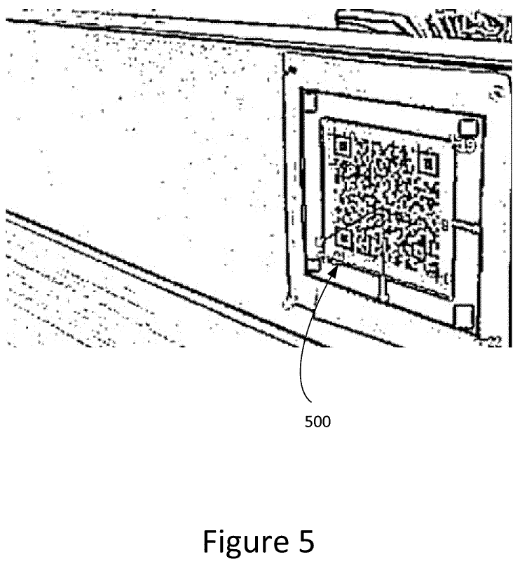

The robot 104A, when traveling using the propelling device 306, may continually update its position using a mix of internal sensors (e.g., odometer) and external sensors (e.g., laser scanners). In embodiments, the guide robot 104A may auto-initialize each time it detects particular machine readable indicia, such as a QR code 500 (FIG. 5) affixed to the walls of the structure or provided elsewhere within the structure. The QR code 500 (and other such QR codes) may contain information regarding its exact location in the map (e.g., information about position and orientation). The data encoded in the QR code 500 may (but need not) be in the form of an XML file. Whenever the guide robot 104A sees the QR code 500, it may extract therefrom its own location on the map. The QR code 500 may also contain links to the map's image file. The QR code 500 may further contain a speed map, which charts the speed limits of the guide robot 104A in the environment. In embodiments, a plurality of such unique QR codes may be provided throughout the area in which the elevators are present to allow the guide robot 104A to quickly determine its position, orientation, and other operating parameters.

In embodiments, the guide robot 104A, when guiding the passenger 110 to the elevator (or when otherwise tracking the passenger) may attempt to maintain a relatively constant distance between the guide robot 104A and the passenger 110. For example, the guide robot 104A may attempt to maintain a one meter (or another) distance between it and the passenger 110 it is guiding and/or otherwise tracking. At periodic intervals, a new goal location (discussed herein) may be calculated and a path may be determined in line therewith. Such may ensure that the passenger 110 is followed by the guide robot 104A so long as the passenger 110 can be tracked using the sensory device 308. If the guide robot 104A is moving with the passenger 110 and the passenger 110 slows down such that the distance therebetween exceeds a threshold distance (such as two meters or another distance), the guide robot 104A may wait for the passenger 110 to catch up. If the passenger 110 does not follow the guide robot 104A during the waiting period, the guide robot 104A may cease servicing the passenger 110 and return to its original location (e.g., a base location, discussed further below) or take other action.

In some embodiments, the passenger 110 must be accompanied by a guide robot 104A or else an alarm may be actuated, access to the elevator may be denied, or another step may be taken (e.g., for security reasons). In other embodiments, the passenger 110 may be allowed to choose whether he or she wishes the guide robot 104A to physically guide the passenger 110 to the elevator assigned to the passenger 110 by the destination dispatch module 102. For example, in an embodiment, once the dialog manager 312A receives an input (e.g., where the passenger 110 uses the input/output device 304 to manually indicate his or her desired floor, where the dialog manager 312A automatically identifies the passenger 110 using the sensory device 308, where the passenger 110 uses the client device 112 to communicate his or her desired floor to the guide robot 104C, etc.), the input/output device 304 may display an interface 400 that: (a) apprises the passenger 110 of the elevator identified for the passenger 110 by the destination dispatch module 102; and (b) includes a button that the passenger 110 may depress or with which the passenger 110 may otherwise interact to convey to the guide robot 104A his or her desire to be guided thereby.

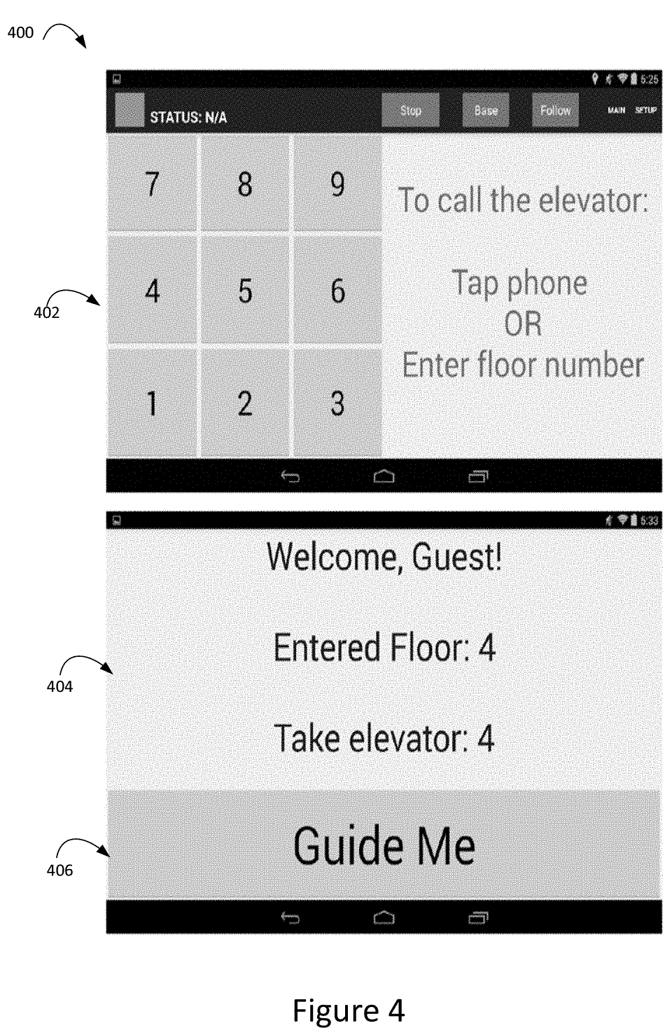

FIG. 4 shows the interface 400, in an example embodiment. The artisan will appreciate that the interface 400 shown in FIG. 4 is exemplary only and is not intended to be independently limiting.

The interface 400 may include an information gathering area 402, an information disseminating area 404, and a button 406. The information gathering area 402 may allow the passenger 110 to enter in information, such as the desired floor. In embodiments, the information gathering area 402 may also display a message indicating that the passenger 110 may tap his or her client device 112 with the guide robot 104A so that the desired floor (and other portions of the profile of the passenger 110) may be communicated to the guide robot 104A via near-field communication. The information disseminating area 404 may outline the desired floor of the passenger 110 and the elevator (e.g., by elevator number) assigned to the passenger 110 by the destination dispatch module 102.

The button 406 may include text such as “guide me” or other suitable text, and the passenger 110 may depress the button 406 to cause the guide robot 104A to guide the passenger 110 to the assigned elevator. In some embodiments, the assigned elevator may be displayed in the information disseminating area 404 for a time period (e.g., three seconds or a different time period) and the passenger 110 may be required to depress the button 406 during this time period to cause the guide robot 104A to guide the passenger 110 to the assigned elevator.

The interface 400 may also be used to allow the passenger 110 (or another, e.g., an administrator of the system 100) to interact with the robot 104A in other ways, such as to cause the guide robot 104A to stop its movement, to return to its base location, to enable the passenger guiding feature, etc. For example, the guide robot 104A may have a designated base location and several goal locations for each elevator. After the guide robot 104A maps the environment, it may be able to autonomously navigate, but without a defined base and/or goal location, it may not comprehend where to navigate to. An administrator of the system 100 may be allowed to set these points via the interface 400, e.g., by enabling person following, taking the guide robot 104A to a base location and/or an elevator goal location, and using the interface 400 to designate that location as one of the base location and/or an elevator goal location. The interface 400 may have a setup page or pages to allow the administrator to so configure the guide robot 104A. The setup pages may also allow the user to set IP port addresses and other such information to enable the guide robot 104A to wirelessly communicate with various components of the system 100 as described herein.

Where the system 100 includes multiple guide robots 104A-104N, the guide robots 104A-104N may communicate with each other to increase the effectiveness of each guide robot 104A-104N and the system 100 as a whole. For example, the multiple guide robots 104A-104N may spread out from the goal location to increase the chances of encountering passengers 110 quickly. The base location may be encoded as a point and a line. The guide robots 104A-104N may line up on this line, adjusting for separation therebetween. If there are two guide robots (e.g., guide robot 104A and guide robot 104B) and one of them (e.g., guide robot 104A) departs from the base to serve the passenger 110, the other guide robot (e.g., guide robot 104B) may move up the line. Similarly, when the guide robot 104A returns after servicing the passenger 110, the robots 104A-104N may communicate with each other to determine the locations on the line at which the plurality of robots 104A-104N will wait for the next passenger. In embodiments, the plurality of guide robots 104A-104N may, during the waiting period, align themselves along the line such that there is an equal distance between adjacent guide robots 104A-104N. Communication between the guide robots 104A-104N may be direct communication between the robots 104A-104N, or may utilize the network 106.

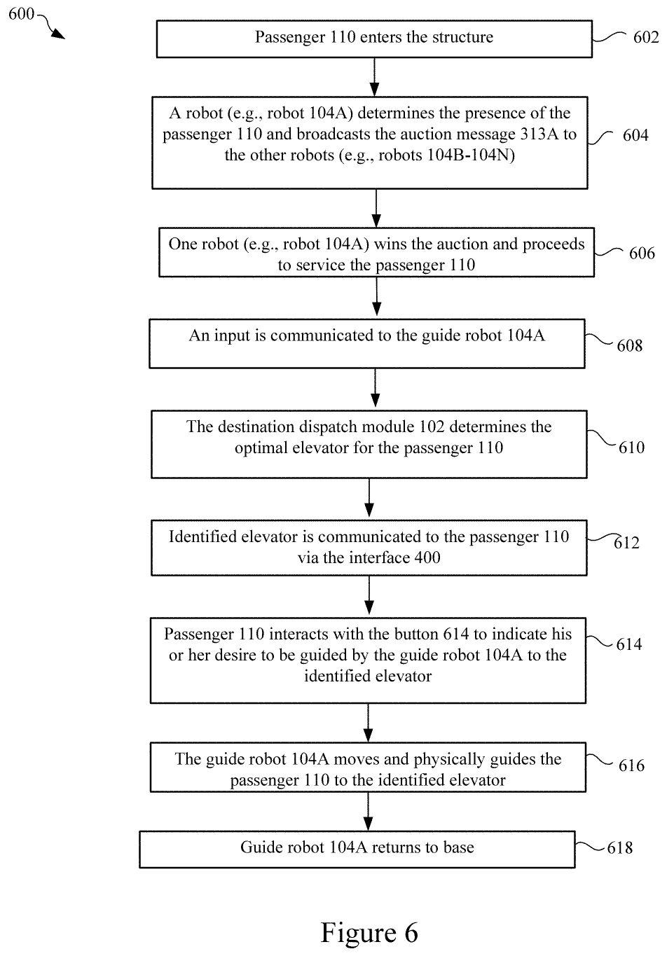

FIG. 6 shows an example method 600 of using the robotic destination dispatch system 100, in an embodiment. At step 602, the passenger may enter the structure, e.g., the lobby thereof. At step 604, a robot (e.g., robot 104A) may determine the presence of the passenger 110 and may send the auction message 313A, which may be broadcasted to the other robots (e.g., robots 104B-104N). At step 606, one of the robots (e.g., robot 104A) may win the auction as discussed above and proceeds to service the passenger 110.

At step 608, an input may be provided to one of the guide robots, e.g., to guide robot 104A. As noted above, the input (e.g., the destination floor, preferences and requirements, etc.) may be provided by the passenger 110 to the guide robot 104A manually, such as by using the input/output device 304 of the guide robot 104A, using the input/output device 206 of the client device, tapping the client device 112 with the guide robot 104A, etc. Alternately or in addition, the input may be provided to the guide robot automatically. For example, the guide robot 104A may capture an image of the passenger 110 and compare same with a previously captured image of the passenger 110 to confirm the identity of the passenger 110; or, the robot 104A may communicate with the client device 112 to determine a unique identification number thereof and use same to identify the passenger 110. As noted above, while the figures show a solitary passenger 110, the passenger 110 may in embodiments be a group of passengers going to the same or different floors.

At step 610, the destination dispatch module 102 may determine the optimal elevator for the passenger 110. At step 612, the identified elevator may be communicated to the passenger 110, e.g., via the interface 400.

At step 614, the passenger may depress the “guide me” button 406 to indicate his or her desire to be guided to the identified elevator by the robot 104A. At step 616, the guide robot 104A, using the sensory device 308, the software 314, the propelling device 306, and/or other components thereof, may move and physically guide the passenger 110 to the identified elevator. Once the passenger 110 has been guided to the identified elevator, at step 618, the guide robot 104A may return to the base and wait for the next passenger.

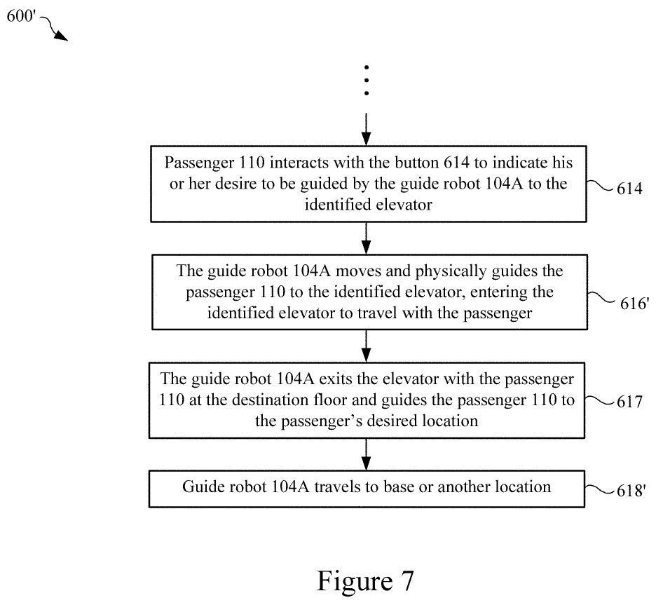

FIG. 7 shows another example method 600′ of using the robotic destination dispatch system 100. Method 600′ may be substantially similar to the method 600 through step 614, and of course both of the methods 600, 600′ may differ (e.g., the passenger 110 may be required to utilize a guide robot 104A-104N, and thus step 614 may be omitted). In the method 600′, step 616 is replaced by step 616′. At step 616′, the guide robot 104A not only moves and physically guides the passenger 110 to the identified elevator, but in doing so enters the elevator 110 to travel with the passenger 110. Then, at step 617, the guide robot 104A exits the elevator 110 with the passenger 110 at the destination floor and guides the passenger 110 to the passenger's desired location (as identified by the passenger 110 along with any other preferences and requirements). So instead of guiding the passenger 110 only to the correct elevator, the passenger 110 is guided all the way to the desired location. From step 617, the method 600′ proceeds to step 618′, where the guide robot 104A travels to the base or another determined location to wait for another passenger.

While the method 600′ has been described with the guide robot 106A traveling with the passenger 110 in the elevator and to the passenger's desired location, in other embodiments the guidance duties are shared between two or more of the robots 104A-104N. For example, the guide robot 104A may guide the passenger 110 to the correct elevator, and the robot 104B may travel with the passenger 110 on the elevator and guide the passenger 110 off the elevator and to the passenger's desired location; or, for example, the guide robot 104A may guide the passenger 110 to the correct elevator, and the robot 104B may meet the passenger 110 as the passenger 110 exits the elevator at the destination floor and guide the passenger 110 to the passenger's desired location. As described above, communication between the guide robots 104A-104N may occur directly between the guide robots 104A-104N and/or through the network 106.

Thus, as has been described, the robotics dispatch system for elevators may be a significant advance over the prior art destination dispatch systems having kiosks and may remedy one or more deficiencies therewith. Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

The disclosure claimed is:

1. A robotic destination dispatch system for elevators, comprising:
a destination dispatch module configured to determine an optimal elevator for a passenger;
a guide robot in wireless data communication with said destination dispatch module, said guide robot having a processor in communication with each of a propelling device, a sensory device, and a memory comprising software, said software comprising computer-readable instructions executable by said processor to:
implement an auction-based scheduling algorithm;
determine an identity of said passenger;
receive from said destination dispatch module an identification of said optimal elevator; and
activate said propelling device to cause said guide robot to move and physically guide said passenger to said optimal elevator.

2. The robotic destination dispatch system of claim 1, wherein said sensory device comprises at least one item selected from the group consisting of: a spatial sensor, a volumetric sensor, and an image sensor.

3. The robotic destination dispatch system of claim 2, wherein said processor is further configured to execute said instructions to cause said guide robot to return to a base after said guide robot has guided said passenger to said optimal elevator.

4. The robotic destination dispatch system of claim 3, wherein said software comprises a dialog manager, a communications manager, a scheduling manager, and a navigation manager.

5. The robotic destination dispatch system of claim 1, wherein said implementation of said auction-based algorithm includes broadcasting of an auction message; and
wherein said auction message includes an identity of said guide robot, an identity of said passenger, and an estimated time of arrival.

6. The robotic destination dispatch system of claim 5, further comprising a client device usable by said passenger to communicate with said guide robot.

7. The robotic destination dispatch system of claim 1, wherein said guide robot includes a plurality of robots, one of which is selected to service said passenger based on said auction-based scheduling algorithm.

8. The robotic destination dispatch system of claim 1, wherein said propelling mechanism includes an actuating motor.

9. The robotic destination dispatch system of claim 1, wherein said processor is further configured to execute said instructions to maintain a distance between said passenger and said guide robot as said passenger is guided by said guide robot.

10. A method for physically guiding a person from an initial location to a desired location, said method comprising:
providing at least one guide robot, each said guide robot respectively comprising:
a processor in communication with each of a propelling device, a sensory device, and a memory comprising software;
receiving an input comprising desired location data; and
causing a first of said at least one guide robot to move via said propelling device of said first guide robot to physically guide said person from said initial location toward said desired location.

11. The method of claim 10, further comprising using machine readable indicia including location information to apprise said guide robot of its current location.

12. The method of claim 10, wherein said input is an automatic input.

13. The method of claim 10, wherein said input is provided by said person via a client device.

14. The method of claim 10, wherein said input is received by said guide robot when said person taps said guide robot with a client device.

15. The method of claim 10, further comprising downloading a mobile application on a client device to allow said person to interact with said guide robot via said client device.

16. The method of claim 10:
wherein said initial location is at a first elevation;
wherein said desired location is at a second elevation different from said first elevation;
wherein causing said first of said at least one guide robot to move via said propelling device of said first guide robot to physically guide said person from said initial location toward said desired location comprises causing said first of said at least one guide robot to move via said propelling device of said first guide robot to physically guide said person from said initial location to an elevator at said first elevation; and
further comprising causing said first guide robot or a second of said at least one guide robot to physically guide said person from said elevator at said second elevation to said desired location.

17. The method of claim 16, further comprising actuating an alarm if said person is separated from each of said first guide robot and said second guide robot by a distance greater than a threshold distance during guidance from said initial location to said desired location.

18. The method of claim 16, wherein said second guide robot physically guides said person from said elevator at said second elevation to said desired location.

19. A robotic destination dispatch system for elevators, comprising:
a destination dispatch module configured to determine an optimal elevator for a passenger;
a guide robot in wireless data communication with said destination dispatch module, said guide robot having a processor in communication with each of a propelling device, a sensory device comprising an imager and a laser sensor, and a memory comprising software, said software comprising computer-readable instructions executable by said processor to activate said propelling device to cause said guide robot to move and physically guide said passenger to said optimal elevator; and
a client device configured to allow said passenger to communicate with said guide robot.

20. The robotic destination dispatch system of claim 19, wherein said guide robot further comprises an interface to allow said passenger to selectively choose to be guided by said guide robot.
